(19) United States
(12) Patent Application Publication
(10) Pub. No.: US 2024/0223599 A1
(43) Pub. Date: Jul. 4, 2024

(54) TECHNIQUES FOR GENERATING APPLICATION-LAYER SIGNATURES CHARACTERIZING ADVANCED APPLICATION-LAYER FLOOD ATTACK TOOLS

(71) Applicant: Radware Ltd., Tel Aviv (IL)

(72) Inventors: Ehud DORON, Moddi'in (IL); Alon TAMIR, Kirya Ono (IL); David AVIV, Tel Aviv (IL)

(73) Assignee: Radware Ltd., Tel Aviv (IL)

(21) Appl. No.: 18/176,667

(22) Filed: Mar. 1, 2023

Related U.S. Application Data
(60) Provisional application No. 63/477,522, filed on Dec. 28, 2022.

(51) Int. Cl. H04L 9/40

(52) U.S. Cl. CPC H04L 63/1458; H04L 63/1425; H04L 63/1433

(57) ABSTRACT

The various disclosed embodiments include a method and system for generating application-layer signatures characterizing advanced application-layer attacks are provided. The method includes determining applicative baseline distributions of attributes included in transactions directed to a protected entity during peacetime; determining attack distributions of applicative attributes included in transactions directed to a protected entity during an on-going application-layer attack; determining, based on the applicative baseline distributions and the attack distributions of applicative attributes, a probability of an attacker executing the on-going application-layer attack to generate an attack using at least one attribute; and generating an application-layer signature designating applicative attributes determined to be eligible based on their respective probabilities, wherein the application-layer signature characterizes behavior of the attacker executing the on-going application-layer attack.

### CROSS-REFERENCE TO RELATED APPLICATIONS

This application claims the benefit of U.S. Provisional Application No. 63/477,522 filed on Dec. 28, 2022, the contents of which are hereby incorporated by reference.

### TECHNICAL FIELD

This present disclosure generally relates to techniques for characterization of application-layer denial of service (DOS) based attacks, and specifically for generating application-layer signatures characterizing advanced application-layer flood attack tools.

### BACKGROUND

These days, online businesses and organizations are vulnerable to malicious attacks. Recently, cyber-attacks have been committed using a wide arsenal of attack techniques and tools targeting both the information maintained by online businesses, their IT infrastructure, and the actual service availability. Hackers and attackers are constantly trying to improve their attack strategies to cause irrecoverable damage, overcome currently deployed protection mechanisms, and so on.

One type of popular cyber-attack is a Denial of Service (“DoS”)/Distributed Denial of Service (“DDOS”) attack, which is an attempt to make a computer or network resource unavailable or idle. A common technique for executing DOS/DDOS attacks includes saturating a target victim resource (e.g., a computer, a WEB server, an API server, a WEB application, other type of applicative servers and the like), with a large quantity of external applicative requests or volume of traffic. As a result, the target victim becomes overloaded, and thus cannot assign resources and respond properly to legitimate traffic or legitimate service requests. When the attacker sends many applicative or other requests towards its victim service or application, each victim resource would experience effects from the DOS attack. A DOS attack is performed by an attacker with a single machine, while a DDOS attack is performed by an attacker controlling many machines and other entities and directing them to attack as a group.

One type of DDOS attack is known as an “Application Layer DDOS Attack”. This is a form of a DDOS attack where attackers target application-layer processes, resources or the applications as a whole. The attack over-exercises specific functions or features of an application to disable those functions or features, and by that makes the application irresponsive to legitimate requests or even terminate or crash. A major sub-class of application layer DDOS attack is the HTTP flood attack.

In HTTP flood attacks, attackers send many manipulated HTTP GET and/or POST and/or other unwanted HTTP requests to attack, or to overload, a victim server, service or application resources. These attacks are often executed by an attack tool, or tools, designed to generate and send floods of “legitimate like” HTTP requests to the victim server. The contents of such requests might be randomized, or pseudo-randomized, in order to emulate legitimate WEB client behavior and evade anti-DoS mitigation elements. Examples of such tools include Challenge Collapsar (CC), Shaphyra, Mirai botnet, Meris botnet, Blood, MHDDOS, DDOSIA, Akira, Xerxes, WEB stresser, DDoSers, and the like.

Recently, a large number of new and sophisticated tools have been developed by hackers and are now being used in various lethal and very high-volume HTTP flood attacks. The need for very simple and accurate solutions for HTTP floods attack mitigation is becoming actual and urgent. Modern on-line services demand for applicative anti-DoS solutions that are required to be able to characterize incoming HTTP requests as generated by attacker or by legit client, all in real-time, with very low false positive rate and very low false negative rate. Attackers keep on improving their attack tools by generating “legitimate like” HTTP requests, resulting in very challenging mitigation and more specific characterization of applicative attacks.

Accurate characterization of HTTP flood attacks executed by such tools is a complex problem that cannot be achieved by currently available solutions for mitigating DDOS attacks. Distinguishing legitimate HTTP requests from malicious HTTP requests is a complex and convoluted task. The complexity of the problem results from the fact that there are dozens of attack tools that behave differently and generate different attack patterns. Further, the attack tools send HTTP requests with a truly legitimate structure (e.g., a header and payload as defined in the respective HTTP standard and follow the industry common practices) and with some parts of their requests' contents being sophisticatedly randomized.

For example, the values of HTTP headers, query argument key and value, WEB Cookie and so on, can all be randomly selected. Furthermore, since the multitude of requests is high (e.g., thousands or tens of thousands of requests in each second) and there is an ever-evolving content of requests, along with the vast usage of randomization, existing DDOS mitigation solutions cannot efficiently and accurately characterize HTTP flood application layer DDOS attacks.

Existing detection solutions approaches are based on calculating the normal baseline during peacetime (when no attack is active or detected), and then any deviation from the baseline is detected as an attack. The baseline is a statistical model calculated or learned over received HTTP requests, representing a normal behavior of a legitimate client accessing the protected server. Upon HTTP flood attack detection, the normal baseline can potentially be used to the actual attacker characterization tasks.

There are major challenges with HTTP flood mitigation solutions that are based on legitimate normal baselining for the purposes of attack characterization. One challenge is due to the ability to realize an accurate baseline on a legitimate non-stationary application or an application with a low rate and bursty traffic. Complementary, during an attack, it is challenging to realize fast and accurate learning the attacker's behavior and understand the attacker patterns needed for generating an accurate and efficient application-layer signature. These challenges are substantial when it is needed to establish application-layer signatures when the attack is carried out by the attacks generating ultra-high volume of random requests. In such cases, there is a relatively low probability that a specific attacker's pattern can be detected and mitigated.

Further, since HTTPS flood attacks employ legitimate-appearing requests with or without high volumes of traffic, and with numerous random patterns, it is difficult to differentiate such requests from valid legitimate traffic. Thus, such types of DDOS attacks are amongst the most advanced non-vulnerable security challenges facing WEB servers and applications owners today.

Therefore, in order to accurately and efficiently characterize an applicative attack tool there is an essential need to compute a unique baseline that accurately model the legitimate behavior of the legitimate clients accessing a protected server or application. Further, such characterization is required to accurately distinguish between various types of legitimate requests (or transactions) and vast types of malicious requests during attack time. In all cases the time to mitigate (“TTM”) should be in the order of seconds.

It would be, therefore, advantageous to provide an efficient security solution for baselining and characterization of HTTPS flood attacks.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Some embodiments disclosed herein include a method for generating application-layer signatures characterizing advanced application-layer attacks. The method includes determining applicative baseline distributions of attributes included in transactions directed to a protected entity during peacetime; determining attack distributions of applicative attributes included in transactions directed to a protected entity during an on-going application-layer attack; determining, based on the applicative baseline distributions and the attack distributions of applicative attributes, a probability of an attacker executing the on-going application-layer attack to generate an attack using at least one attribute; and generating an application-layer signature designating applicative attributes determined to be eligible based on their respective probabilities, wherein the application-layer signature characterizes behavior of the attacker executing the on-going application-layer attack.

Some embodiments disclosed herein include a system for generating dynamic applicative signatures of by application layer flood attack tools. The system includes a processing circuitry; and a memory, the memory containing instructions that, when executed by the processing circuitry, configure the system to: determine applicative baseline distributions of attributed included in transactions directed to protect an entity during peacetime; determine attack distributions of applicative attributes included in transactions directed to a protected entity during an on-going application-layer attack; determine, based on the applicative baseline distributions and the attack distributions of applicative attributes, a probability of an attacker to execute the on-going application-layer flood attack to generate an attack that uses at least one attribute; and generate an application-layer signature that designates applicative attributes determined to be eligible based on their respective probabilities, wherein the application-layer signature characterizes behavior of the attacker executing the on-going application-layer attack.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is schematic diagram utilized to describe the various embodiments for characterization application-layer flood attacks according to some embodiments.

FIG. 2A is a flowchart illustrating the characterization of HTTP flood attacks according to an embodiment.

FIG. 2B is a flowchart illustrating the creation of window paraphrase buffers according to an embodiment.

FIG. 3 is an example structure paraphrase vector generated according to an embodiment.

FIG. 4 is a flowchart illustrating the process of generating a paraphrase vector according to an embodiment.

FIG. 5 is an array of paraphrase buffers generated according to an embodiment.

FIG. 6 is a flowchart illustrating a process for generating application-layer signatures characterizing advanced application-layer flood attack tools according to an embodiment.

FIG. 7 is a chart demonstrating the transformation from histograms to paraphrase distributions.

FIG. 8 is a block diagram of a device utilized to carry the disclosed embodiments.

### DETAILED DESCRIPTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural, and vice versa, with no loss of generality. In the drawings, like numerals refer to like parts through several views.

The various disclosed embodiments include a method for baselining and characterization of HTTP flood DDOS attacks. The disclosed method characterizes malicious requests over legitimate requests, to dynamically generate signatures of the attack tools. The generated signatures may allow efficient mitigation of HTTP flood attacks. In an embodiment, the disclosed method can be performed by a device in an out-of-path or an in-line always-on deployment. The various disclosed embodiments will be described with reference to an HTTP flood DDOS attack, but the techniques disclosed herein can be utilized to characterize flood DDOS attacks generated by other types of application layer protocols.

According to the disclosed embodiments, a signature of an attack tool is a subtraction of attack paraphrase distributions from baseline paraphrase distributions. Such distributions are determined or otherwise computed using paraphrase buffers. For the purpose of this disclosure and without limiting the scope of the disclosed embodiments, the following terms (either in their singular or plural form) are being utilized: a paraphrase; a paraphrase vector; a paraphrase buffer, which is a set of paraphrase values; paraphrase buffers, which are a set of paraphrase buffer; baseline paraphrase distribution; baseline paraphrase distributions, which are a set of baseline paraphrase distribution; attack paraphrase distribution; and attack paraphrase distributions, which are a set of attack paraphrase distribution. A paraphrase characterizes the structure of a layer-7 transaction (e.g., HTTP request). That is, a paraphrase maintains the attributes of an incoming transaction. Each paraphrase includes one or more paraphrase values. A paraphrase vector includes a set of paraphrases. The paraphrases are used to generate the required applicative (Layer 7) signatures characterizing the attacker's applicative attributes for the purpose of the attack mitigation.

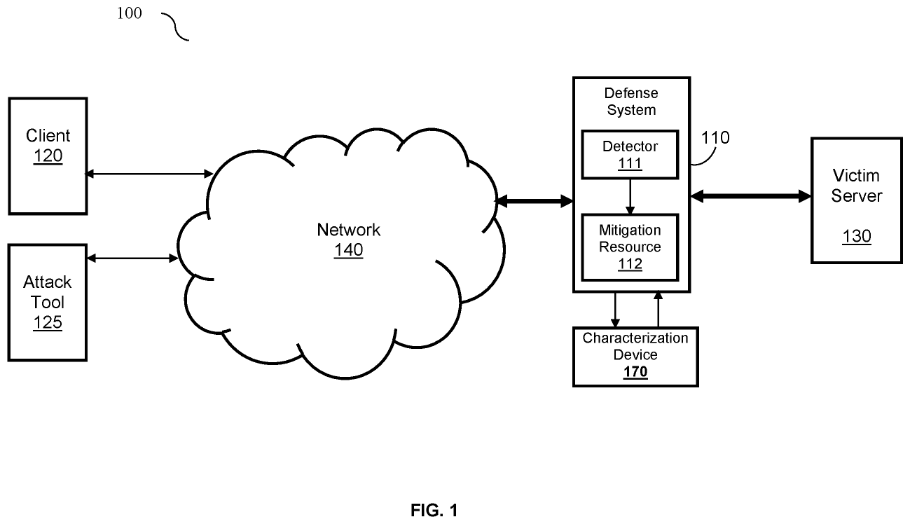

FIG. 1 is a schematic diagram 100 utilized to describe the various embodiments for characterization and mitigate HTTP flood attacks according to some embodiments. In schematic diagram 100, client devices 120 and 125 communicate with a victim server (or simply a server) 130 over a network 140. To demonstrate the disclosed embodiments, the client device 120 is a legitimate client (operated by a real legitimate user, or other types of legitimate WEB client entities), a client device 125 is an attack tool (operated, for example, as a bot by a botnet), and the server 130 is a “victim server”, i.e., a protected server 130 under attack.

The legitimate client device 120 can be a WEB browser, or other type of legitimate WEB application client or user agent, and the like executing over a computing device, such as a server, a mobile device, an IoT device, a laptop, a PC, a connected device, smart TV system and the like.

The attack tool 125 carries out malicious attacks against the victim server 130, and particularly carries out HTTP flood attacks. The attack tool 125 used by an attacker to generate and send “legitimate-looking” HTTP requests toward the victim server. The attacker's generated HTTP requests having the correct structure and content as required by the HTTP protocol, and by that these requests look “legitimate” even though they are malicious, as they were generated by an attacker with malicious purposes. In order to make the attack mitigation to be a very complex task, the attacker makes large use of randomization or pseudo-randomization. In some cases, the attacker generates a large set of distinct “legitimate” requests while randomly selecting the request to be transmitted. It should be noted that the attacker generates a large number of distinct HTTP requests to be able to evade fingerprinting and mitigation by simple WEB filtering or others attack mitigation means.

The attack tool 125 may be an HTTP flood attack tool that can be deployed as a botnet using WEB proxies, or as an HTTP flood attack tool without using WEB proxies. The attack tool 125 also can be deployed as a WEB stresser, DDoSers, and other “DDOS for hire” forms of attacks.

The attack tool 125 generates requests with a legitimate structure and content. To obtain the “legitimate structure,” attacker generated HTTP requests may include a legitimate URL within the protected application, a set of standard and non-standard HTTP headers, WEB Cookie, and contain one, or more, query arguments. The attack tool 125 can constantly include a specific HTTP header, or query arguments, in its generated HTTP requests or randomly decide to include them or not in each request or set of requests generated. The attack tool can also randomly select the attacked URL to be addressed in each of the requests it generates.

The attack tool 125 generated requests can also contain legitimate and varied content, or values. To make its generated requests “look” legitimate, the attack tool generated HTTP requests can have HTTP headers with legitimate values (e.g., UserAgent can be randomly selected from a predefined list of legitimate UserAgent, References can be randomly selected from a predefined list of legitimate and common WEB sites, e.g., facebook.com, google.com).

These overall operations of the attack tool 125 result of a set of tens of thousands, or even millions, of the attacker's distinct HTTP requests that can be potentially sent to the victim server 130. The attacker uses randomization to select the actual HTTP request to send toward its victim in each request transmission. Therefore, aiming to simply, or manually, recognize the millions of distinct attacker's requests “as is” by human operation teams will be a very tedious task, almost impossible. It is important to note that these tools have numerous mutations and variants, but still follow similar operations, and the HTTP requests they generated are as described above. Advanced attack tools are designed to bypass simple Layer-7 filtering for mitigation by generating a large set of distinct and “legitimate-looking” HTTP requests. As such, no dominate, or frequent, set of several HTTP requests can be characterized as issued by the attack tool 125.

Requests generated by the legitimate client(s) are more diverse in their structure comparing to the attacker's requests. The legitimate client HTTP requests potentially have more HTTP headers, standard and non-standard headers, turn to plurality of URLs within the protected entity which may include the victim server 130, have more key-values pairs in Cookie, use more query arguments, and similar. Based on the higher diversity and content distribution of legitimate requests, the legitimate traffic applicative normal baseline is calculated, and the accurate learning of legitimate requests behavior is possible.

It should be noted that the embodiments disclosed herein are applicable when multiple attack tools execute the attacks against the victim server 130 concurrently. Similarly, a vast number of legitimate client devices 120 can operate concurrently to be delivered with the services proposed by server 130. Both client devices 120 and 125 can reach the victim server 130 concurrently. The network 140 may be, but is not limited to, a local area network (LAN), a wide area network (WAN), the Internet, a public or private cloud network, a cellular network, and a metropolitan area network (MAN), wireless network, IoT network, a corporate network, a datacenter network or any combination thereof.

According to the disclosed embodiments, a defense system 110 (hereinafter “the system 110”) is deployed between client device 120, attack tool 125, and victim server 130. The system 110 is connected to a characterization device 170 (hereinafter “the device 170”) configured to carry out the disclosed embodiments. Specifically, during peace time, the device 170 is configured to analyze requests received from the system 110 and learn the legitimate traffic applicative baselines. During an attack the device 170 uses the calculated applicative baselines to build a dynamic applicative signature, or signatures, characterizing the attack tool 125 (or the attacker) HTTP requests. The signature generated by device 170 may allow a mitigation action or policy selection. The mitigation action may be carried out by system 110. In other embodiment the mitigation actions are realized in the device 170.

An indication of an on-going attack is provided to the device 170 by the system 110. The techniques for the detection of on-going attacks are outside of the scope of the disclosed embodiments. Example techniques for detection of an on-going layer-7 DDOS attacks can be found in U.S. patent application Ser. No. 18/058,482, titled TECHNIQUES FOR DETECTING ADVANCED APPLICATION LAYER FLOOD ATTACK TOOLS, assigned to the common assignee, and hereby incorporated for that it contains.

The system 110 may be deployed in an in-line or in an always-on mode, or in other types of deployments that allow peace time baselining of incoming applicative transactions.

The system 110, device 170, and the victim server 130 may be deployed in a cloud computing platform and/or in an on-premises deployment, such that they collocate together, or in a combination. The cloud computing platform may be, but is not limited to, a public cloud, a private cloud, or a hybrid cloud. Examples for cloud computing platforms include Amazon® Web Services (AWS), Cisco® Metacloud, Microsoft® Azure®, Google® Cloud Platform, and the like. In an embodiment, when installed in the cloud, the device 170 may operate as a SaaS or as a managed security service provisioned as a cloud service. In an embodiment, when installed on-premise, the device 170 may operate as a managed security service.

In an example configuration, the system 110 includes a detector 111 and a mitigation resource 112. The detector 111 in the system 110 is configured to provide an indication of an on-going attack. The mitigation resource 112 is configured to perform one or more mitigation actions triggered by the detector 111, to mitigate a detected attack. The mitigation resource may be, but is not limited to, a scrubbing center or a DDOS mitigation device. In an embodiment, the system 110 and/or the device 170, are integrated in a DDOS mitigation device. In another embodiment, the system 110 and/or the device 170 is a multi-tiered mitigation system. The arrangement, configuration, and orchestration of a multi-tiered mitigation system are disclosed in U.S. Pat. No. 9,769,201, assigned to the common assignee, which is hereby incorporated by reference.

In an embodiment, the system 110 and/or the device 170, are integrated in a WAF (Web Application Firewall) device. In yet another embodiment, the system 110 and/or the device 170, are integrated together in any form of WEB proxy or a WEB server. In yet another embodiment, the system 110 and/or the device 170 can be integrated in WEB caching systems like CDN and others.

The victim server 130 is the entity to be protected from malicious threats. The server 130 may be a physical or virtual entity (e.g., a virtual machine, a software container, a serverless function, and the like). The victim server 130 may be a WEB server (e.g., a server under attack, an on-line WEB server under attack, a WEB application under attack, an API server, a mobile application, and so on).

According to the disclosed embodiments, throughout peace time and during an active attack, device 170 is configured to inspect applicative transactions received from the system 110. The transactions are applicative requests, such as HTTP requests sent to the victim server 130 by both legitimate client device 120 and attack tool 125. The transactions are received at the device 170 during peace time for the purpose of learning and baselining the normal applicative behaviors needed for the attack characterization, applicative signature generation all for the purpose of accurate and efficient attack mitigation. Upon detection of an active attack by the detector 111, the device 170 continues to receive the incoming transactions throughout the entire attack duration. During an active attack, the device 170 is configured to analyze the received transactions and determine if an HTTP request's structure is of the attack tool (125) executing the detected attack, or a legitimate HTTP request sent by client device 120. The device 170 reports its decision on each of the received requests to the system 110. The decision can be to mitigate the request or to safely pass the requests to the victim server 130.

In yet another embodiment, and in order to improve the efficiency and cost structure of the device 170, the device 170 is fed and updated by samples of the incoming HTTP transactions. The sampling can be for 1 in N received transactions, the first received N transactions in a time window, and similar. In yet another embodiment, the sampling rate N can be different for peace time conditions and attack time conditions, to better adjust to the number of HTTP requests transmitted toward the protected entity.

For improving efficiency and cost, other embodiments can be suggested. Here, during an active attack, the device 170 is only responsible for dynamically building the required accurate signature. Complementary, the system 110 is responsible for the actual, per transaction, mitigation activities. The device 170 is configured to pass continuously the signature to the system 110, which uses the signature for the attack mitigation. During an active attack the system 110 is configured to analyze each incoming request, compare the request to the signature provided by the device 170, and decide, on a per transaction basis, whether the transaction was generated by the client device 120, i.e., the transaction is legitimate and should be passed safely, or that the transaction was generated by the attack tool 125, i.e., the transaction is an attack and should be mitigated. In such an embodiment, the device 170 can also function by analyzing all transactions without any sampling (peace and attack time).

Specifically, system 110 is configured to sample the incoming traffic, i.e., HTTP requests, and generate the signatures. Specifically, a signature of an attack tool can be generated, modified, or updated every time window. A time window is a preconfigured time period, e.g., 10 seconds. Three (3) paraphrase buffers can be updated during each time window: window, baseline, and attack. A window paraphrase buffer is provided at each time window, a baseline paraphrase buffer is updated during peacetime (no active attack) each time window, attack paraphrase buffers are provided during the attack at each time window.

The device 170 is configured to identify the paraphrase values demonstrated in requested sent by the attack tool 125 and legitimate client, and to distinguish between them. To this end, the device 170 is configured to compare between the application's normal, peacetime, paraphrase behavior and attack time paraphrase behavior. This is realized by the comparison of peacetime paraphrase distribution from attack time paraphrase distribution. The signatures generated by the device 170 can be configured at the mitigation resource 112 to allow effective mitigation of the attack. That is, transferring safely the legitimate traffic to the protected server 130 and taking the required mitigation action on the attacker's malicious traffic based on the generated signatures

In an example embodiment, a mitigation action may be performed, by the mitigation resource 112, selectively on the attacker traffic only. Mitigation action can be a simple blocking of the request, a response on behalf of the server 130 with a dedicated blocking page, or similar. In yet another embodiment, the mitigation action may include limiting the rate of attacker traffic or merely reporting and logging the mitigation results without any actual blocking of the incoming request. In another embodiment, the mitigation action can be issue various type of challenges, e.g., captcha, to better identify the client as coming from legitimate user or attack tool operated as a bot. Further, the generated signatures can be utilized to update a mitigation policy defined in the mitigation resource 112.

In the example deployment, show in FIG. 1, the system 110 is connected in-line with the traffic between the client device 120 and the attack tool 125 toward the victim server 130. In this deployment, the system 110 is configured to sample and process ingress traffic from the client device 120 and the attack tool 125.

In some configurations, the system 110 is also connected out-of-traffic where traffic is diverted by a switch/router, a WEB proxy (not shown), or by the protected server, to processing by the system 110. In such configurations, the device 170 is also connected out-of-path.

In yet another configuration, the system 110 may be always-on deployment. In such a deployment, the system 110 and the device 170 can be part of a cloud protection platform (not shown).

In another embodiment, the device 170 is integrated with the system 110. In such an embodiment, the processing of requests by the device 170 is performed at both peace time and the time of the attack, regardless of the deployment of the integrated system. This integrated system can be a DDOS mitigation device, a Web Application Firewall, and the like.

It should be noted that although one client device 120, one attack tool 125, and one victim server 130 are depicted in FIG. 1 merely for the sake of simplicity, the embodiments disclosed herein can be applied to a plurality of clients and servers. The clients may be located in different geographical locations. The servers may be part of one or more data centers, server frames, private cloud, public cloud, hybrid cloud, or combinations thereof. In some configurations, the victim server 130 may be deployed in a data center, a cloud computing platform, or on-premises of organization, and the like. The cloud computing platform may be a private cloud, a public cloud, a hybrid cloud, or any combination thereof. In addition, the deployment shown in FIG. 1 may include a content delivery network (CDN) connected between client device 120, attack tool 125 and server 130.

System 110 and device 170 may be realized in software, hardware, or any combination thereof. System 110 and device 170 may be a physical entity (an example block diagram is discussed below) or a virtual entity (e.g., virtual machine, software container, micro entity, function, and the like).

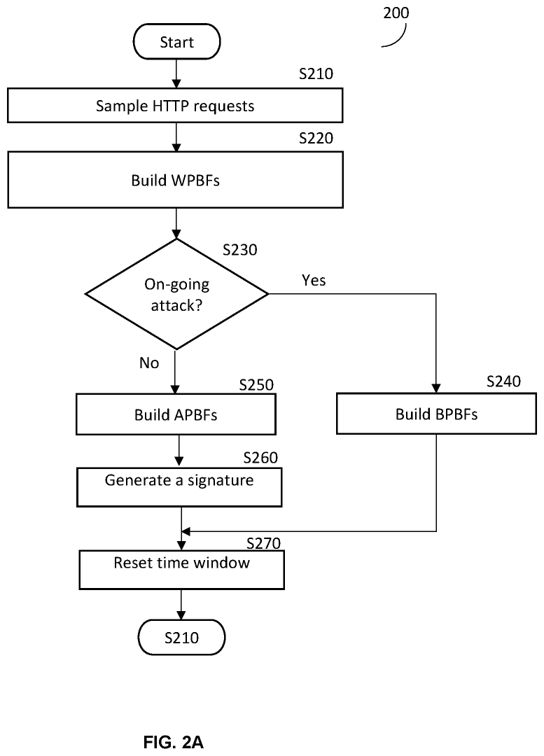

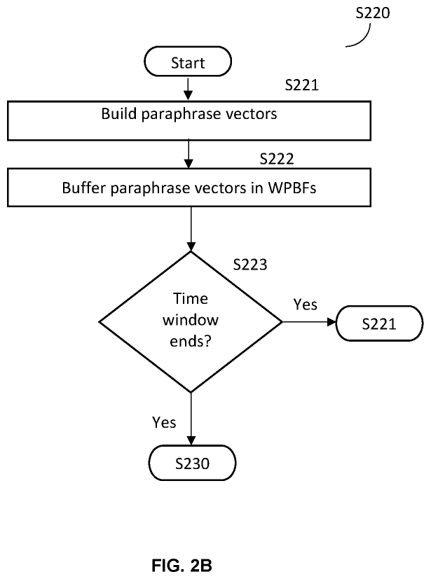

FIG. 2A shows an example flowchart 200 illustrating the characterization of HTTP flood attacks for the purpose of generating application-layer accurate attack signatures based on applicative normal baseline learned during peace time, according to an embodiment. During an active attack, the method is designed to characterize requests generated by attackers using HTTP flood tools, such as, for example, those mentioned above, and to distinguish the legitimate requests from the attackers' requests.

The characterization is based on distinguishing the structure of legitimate HTTP requests from the structure of malicious requests based on the legitimate traffic applicative baseline structure learned during peace time. The signature generation process discussed herein is adaptive and capable of learning a vast number of different attack tools. A new signature may be generated at the end of every time window. As such, the method presented in FIG. 2A operates at each time window. It should be emphasized that the new signatures are generated or updated only during an active attack time, correspondingly, the application's legitimate behavior normal baseline is learned only during peace time. It should be noted that a signature is an application-layer accurate and efficient signature of an attack tool, such as those mentioned above. The generated signature can be utilized by mitigation resources to efficiently enforce a mitigation action. That is, a mitigation resource may check for a match of each incoming request to the generated signature and, based on the match, a mitigation action may be applied. For simplicity, we will refer to an application-layer signature as a “signature.”

At S210, HTTP requests directed to a protected object (e.g., server 130, FIG. 1) are sampled. The requests are sampled and processed during a time window regardless of if there is an on-going DDOS attack. Alternatively, S210 may include receiving samples of the requests. In yet another embodiment, S210 may include receiving and analyzing all the transactions without any sampling.

At S220, window paraphrase buffers (WPBFs) are built for a current time window. At peacetime and at attack time, the WPBFs represent the current window paraphrases' behavior. In an embodiment, S220 includes vectoring the HTTP requests, sampled or not, into paraphrase vectors and updating the window paraphrase buffers using their respective paraphrase values. The WPBFs provide a histogram of the structure of requests received during the current time window. The operation of S220 is discussed in more detail with reference to FIG. 2B.

Referring now to FIG. 2B, at S221, the incoming request is processed and placed in, or represented as, a respective paraphrase vector. The characterization, and signature generation, is based on understanding the structure of the requests and not the contents of the request. Such structure representation is referred to here as a paraphrase. A paraphrase vector is a data structure that represents attributes of incoming HTTP requests' structure according to a notation of a respective paraphrase.

In an example embodiment, the following HTTP request attributes are included in a “paraphrase vector” of HTTP request: HTTP VERB (GET, POST, PUT, and such); a number of path elements in the request URL path; a number of query arguments in the request URL; a number of key:values cookie elements in cookie; a length of User Agent header value; the User Agent actual value; the total length in bytes of the request; a total number of “known HTTP headers” (standard HTTP headers); and a total number of “unknown headers”, i.e., all HTTP headers that are not standard HTTP headers according to any existing standards or alternatively defined. The existence, or non-existence, of a predefined set of HTTP headers are also included as paraphrases in the system paraphrase vector. This set of specific HTTP headers can be composed of standard or non-standard HTTP headers. In yet another embodiment, the paraphrase vector entities are learned dynamically, to be adaptive with the incoming traffic of a specific application.

In an embodiment, the definition of standard headers or non-standard headers can be defined dynamically. In yet another embodiment, and in order to adapt to various types of protected applications, the actual HTTP request attributes are considered a paraphrase and are included in a paraphrase vector, can be defined dynamically, learned over time, and so on. In yet another embodiment, the paraphrase vector entities are dynamically defined by the user operating the system to be adaptive to the protected application's operational or others, needs.

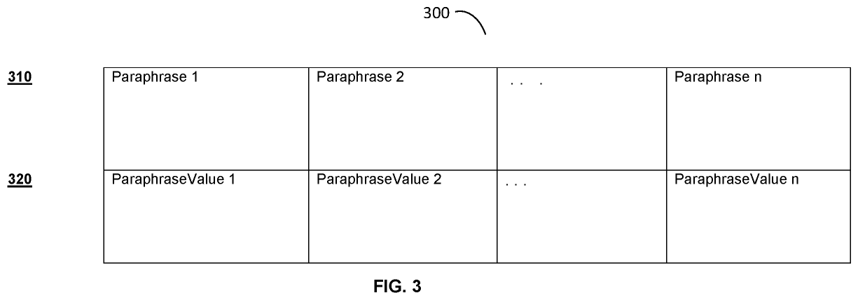

An example paraphrase vector 300 is shown in FIG. 3, where row 320 represents the paraphrase values of the respective paraphrase (attribute) in row 310. The paraphrase value can be either an integer number (e.g., number of cookie elements in the Cookie HTTP header, request size ranges), string (e.g., HTTP method type), or binary (exists or does not exist for a specific HTTP header from a predefined list).

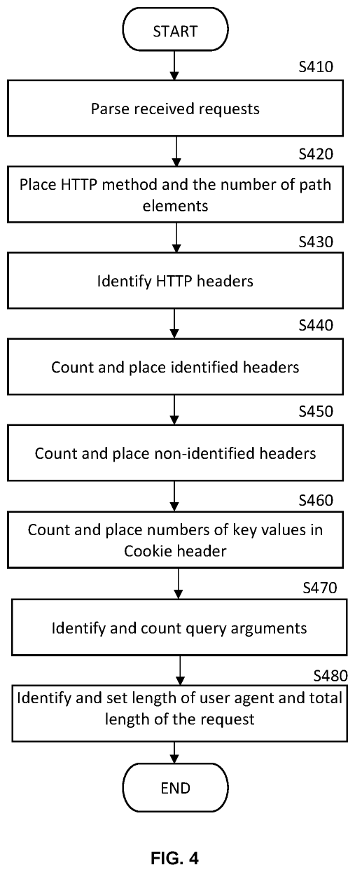

The conversion or placing of values from the received HTTP request in the paraphrase vector depends on the respective attributes. A process for generating a paraphrase vector is further discussed with reference to FIG. 4.

As the paraphrases represent the HTTP request structure, and there is a substantial difference between attacker and legitimate client request structure, it is assumed that paraphrase vector of received HTTP requests should be used for attacker characterization in reference to the normal legitimate client applicative baseline structure behavior. Requests sent by attacker, or attackers, can be represented using a relatively small number of paraphrases, and hence paraphrase vectors. That is, the paraphrase vector represents the structure of a request. However, multiple different requests can share the same paraphrase, as the actual content of a request is not part of its paraphrase vector. It should be appreciated that using this approach, a large number (e.g., tens, thousands or millions) of attacker distinct HTTP requests are represented as a small set of paraphrases. This small set represents the HTTP requests generated by the attacker, or attackers, (e.g., attack tool 125, FIG. 1), and not by most of the legitimate clients as their paraphrase vectors are much more diverse, therefore not repetitive, and are higher in their count. The attacker traffic is represented as a set of paraphrases, and their differences from the legitimate paraphrases behavior, is the foundation of building the applicative signature.

Referring now to FIG. 2B, at S222 the paraphrase vectors, corresponding to the incoming sampled (or not sampled) HTTP requests, are buffered into an array of paraphrase buffers to provide the WPBFs. The WPBFs can be referred to as a set of paraphrase buffer represents the current window paraphrase behavior. The array is a data structure that maintains the overall occurrences of each paraphrase value, for each paraphrase, over the incoming traffic during the current time window for peace time and also, during an active attack, for attack time windows. The array contains the same paraphrases as defined for a paraphrase vector (e.g., HTTP VERB, number of path elements in the request URL path, and exists/not exists headers), such that each paraphrase has its paraphrase buffer. A paraphrase buffer is a data structure constructed to include values of a single paraphrase. For each possible paraphrase value, the buffer has the actual “value” field along with an “occurrences” field. The occurrences represent the total aggregated number of HTTP requests with the specific value that appeared for the specific paraphrase. For each protected entity (e.g., victim server 130, FIG. 1), a single dedicated WPBFs array is maintained.

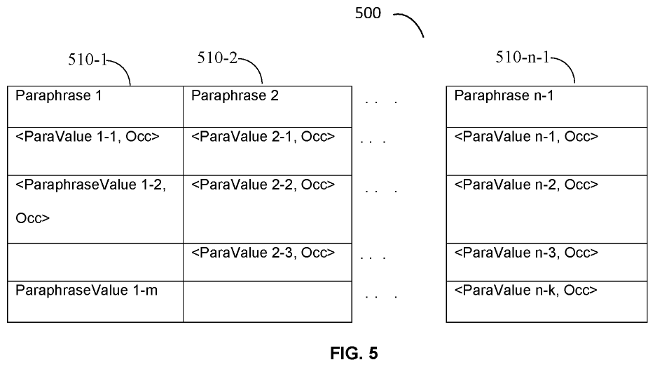

An example array 500 of paraphrase buffers is shown in FIG. 5. The array 500 includes a list of paraphrase buffers 510. Each buffer holds a list of respective paraphrase values and the number of occurrences counted for the same value. Each paraphrase can have a different number of paraphrase values. As an example, if the incoming vectors are aggerated (representing 10 different HTTP requests), and there are 5 vectors with GET method, 4 vectors POST method, and 1 vector with HEAD method, the number of occurrences for the paraphrase values GET POST, and HEAD would be 5, 4, and 1 respectively. In an example embodiment, the possible paraphrase values are predefined for each type of paraphrase. In an embodiment, the array 500 can serve for WPBFs, attack paraphrase buffers, and baseline paraphrase buffers.

Referring back to FIG. 2B, in an embodiment, S222 includes updating the respective paraphrase buffer in the array with each sampled HTTP request. In this embodiment, the vector generated or updated in response to a received HTTP request, with or without sampling, is scanned, and an occurrence count in the paraphrase buffer is incremented by one for each corresponding paraphrase value in the scanned vector. At the beginning of each time window, the occurrences count is set to zero; for a first seen paraphrase value the occurrences count is set to one.

At S223, it is checked if the time window has elapsed, and if so, execution continues with S230 (FIG. 2A); otherwise, execution returns to S221, where the building of the WPBFs continues. In some embodiments, it is checked if the number of requests being processed is over a predefined threshold. In this case, all occurrences values in all paraphrase buffers is multiplied by, for example, a factor of 0.5 or another predefined number smaller than 1, such that warp-around is avoided.

Returning to FIG. 2A, where at S230, it is checked if an attack indication has been received during the time window or beforehand. Such indication may be received from a detection system (e.g., system 110, FIG. 1). If an attack indication has not been received, execution continues with S240; otherwise, execution continues with S250.

At S240, baseline paraphrase buffers (BPBFs) are built based on the WPBFs. The BPBFs represent the paraphrase peacetime normal applicative behavior, or the legitimate paraphrase behavior. In an embodiment, S240 may include updating BPBFs with paraphrase value occurrences aggregated in the WPBFs from the latest time window. Then, execution continues with S270, where all occurrences' values in the WPBFs are cleared, and a new time window starts. Then execution returns to S210 for processing a new time window. It should be noted that the structure of the BPBFs is the same as the WPBFs buffers. It should be further noted BPBFs are updated at any time window if no attack indication is received.

In an embodiment, during peace time at the end of each time window, updating the BPBFs with values aggregated in the WPBFs is realized using an Alpha filter to compute a paraphrase value mean occurrences of paraphrase values in the BPBFs for the current time window. In an embodiment, the paraphrase values mean occurrences are computed as follows:

$${ParaValueOccMean}_{i , j} [ n + 1 ] = {ParaValueOccMean}_{i , j} [ n ] \cdot ( 1 - α ) + {WinParaValueOcc}_{i , j} [ n + 1 ] \cdot α \qquad Equ . 1$$

where, ParaValueOccMean_{i,j} [n] is the average occurrence for paraphrase value i, belongs to paraphrase j, for time window n. The WinParaValueOcc_{i,j} [n+1] is the total window occurrences for paraphrase value i, belongs to paraphrase j, as calculated in time window n+1. The a is the alpha coefficient, which defines an Alpha filter “integration” period. The “integration period” refers to the length of time that it takes to integrate. The integration period is the time on the averaging performed by the Alpha filter. In an example embodiment, the Alpha coefficient is selected as 0.001 to enable an approximation of five-hour integration period.

At S250, when there is an on-going attack, attack paraphrase buffers (APBFs) are built. The APBFs represent the paraphrase attack time behavior over the time windows, starting from the first window where the attack was detected and throughout an active on-going attack. During an on-going attack, the APBFs are updated with paraphrase value occurrences aggregated in the WPBFs from the latest time window. This is performed for each time window during the indication of an on-going attack. It should be noted that updating the APBFs does not require updating the BPBFs, thus the contents of the BPBFs remain the same during attack time.

In an embodiment, during an active attack, at the end of each time window, the APBFs are updated with values aggregated in the WPBFs using a simple summation of current window occurrences to the attack aggregated summation.

In yet another embodiment, a generated signature can be rapidly adapted to the attacker requests' structure. To this end, during an active attack, at the end of each time window, the APBFs are updated with values aggregated in the WPBFs using an Alpha Filter with a short integration period. The update is made such that the paraphrase values mean occurrences in APBFs is computed as follows:

$${AtatckParaValueOcc}_{i , j} [ n + 1 ] = {AtatckParaValueOcc}_{i , j} [ n ] \cdot ( 1 - α ) + {WinParaValueOcc}_{i , j} [ n + 1 ] \cdot α \qquad Equ . 1.1$$

where, AttackParaValueOcc_{i,j}[n] is the average occurrences for paraphrase value i, belongs to paraphrase j, for time window n, in APBFs. The WinParaValueOcc_{i,j} [n+1] is the total window occurrences for paraphrase value i, belongs to paraphrase j, as calculated in a time window n+1. The a is the alpha coefficient, which defines the Alpha filter “integration” period. In an example embodiment, the Alpha is selected as 0.75 to enable the fast integration time, e.g., a couple of ten seconds, required for the fast adaptation to the attacker requests' structure.

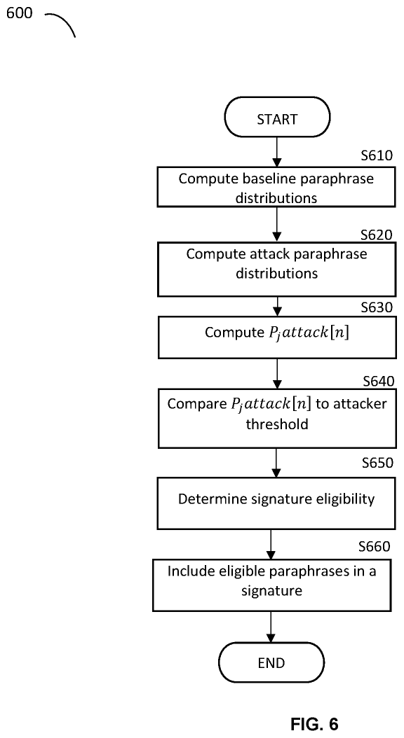

At S260, a signature of an attack tool (attacker) initiating the on-going DDOS attack is generated based on the BPBFs and APBFs. The signature includes the optimal set of paraphrase values that can efficiently block the attacker-generated HTTP requests executing the application layer DDOS attack. S260 is discussed in greater detail in FIG. 6.

In an embodiment, the generated signature is provided to a mitigation resource to perform a mitigation action on attack traffic. To this end, the mitigation resource may be configured to compare each request to the generated signature and, if there is a match, apply a mitigation action on the request. It should be noted that S250 and S260 are performed as long as the attack is a DDOS attack is on-going. An indication of an end-of-attack may be received from the detector. Such an indication would halt the generation of new signatures and any mitigation actions. After the end of the attack, a detection action is indicated, and an attack mitigation grace period may be initiated. In an embodiment, the APBFs are not updated throughout the grace period time. The signature can be kept or removed during the grace period, predefined as part of the system configuration. The grace period is a preconfigured timeline.

A mitigation action may include blocking an attack tool at the source when the tool is being repetitively characterized as matched to the dynamic applicative signature. In the case a client, identified by its IP address or X-Forwarded—For HTTP header, issues a large rate of HTTP requests that match with the dynamic applicative signature, this client can be treated as an attacker (or as an attack tool). After a client is identified as an attacker, all future HTTP requests received from the identified attacker are blocked without the need to perform any matching operation to the signature.

In some configurations, the matching of requests to signatures may include matching each paraphrase of request's paraphrase vector, to the signature. The match strictness can be configured to determine the sensitivity of the method. The sensitivity may affect the false-positive ratio of legitimate requests detected as malicious. The range of a match can be determined in percentage, where 100% would be when all the incoming paraphrase vector's values are the same as the corresponding signature. This strict match strategy can eliminate the false-positive ratio but may, in some cases, increase the false-negative ratio. To ease the matching requirements, the percentage of matching paraphrase vector's values would be, for example, between 80% and 90% (or match for all paraphrases besides 2 or 3 paraphrases). The matching percentage is a configurable parameter. The match strictness is defined in terms of the number of allowed unmatched paraphrases.

FIG. 4 is an example flowchart illustrating a process for generating a paraphrase vector according to an embodiment.

At S410, sampled HTTP requests are parsed. Specifically, the HTTP request's fields headers, and other components, are parsed and processed. At S420, the information in the HTTP method's field is copied from the request into its corresponding “HTTP Method” paraphrase value cell in the vector. The value can be “GET,” “POST,” or “HEAD,” or any other HTTP method.

At S420, the number of path elements is counted from the URL path designated in the request. Every “\” is counted. For example, for the path “\pictureslimages\2021\July\” the value is 4. For the root “\” its paraphrase is 0.

At S430, known HTTP headers are identified in the parsed request. This can be performed by first finding (e.g., using regular expression) all strings designated as known headers. For example, the Accept* paraphrase is built by finding the existences of all HTTP headers starting with ‘Accept —*’ (e.g., Accept, Accept-Encoding, Accept-Language, and so on). If at least one Accept* header is found in a request, then the paraphrase value is EXIST. Otherwise, the paraphrase value will be NOT-EXIST. In an embodiment, the known headers include, yet are not limited to, the following headers: Referrer, User-Agent, Host, Authorization, Connection, Cache-Control, Date, Pragma, Expect, Forwarded, From, Max-Forwards, Origin, Prefer, Proxy-Authorization, Range, Transfer-Encoding, Upgrade, Via, Accept* (all HTTP headers that starts with Accept), Content* (all HTTP headers that starts with Content), Sec- (all HTTP headers that starts with Sec-), and If —* (all HTTP headers that starts with If-), and similar HTTP headers, standard and not standard. In an embodiment, the known headers are defined using a static list of standard HTTP headers. In yet another embodiment, the known headers can be defined dynamically and learned upon their appearance in the incoming HTTP transactions.

At S440, all identified known headers are counted, and the respective value is set as a paraphrase value for the total number of “known HTTP headers.” Each appearance of a known header is counted as 1, and the total count of all headers “known HTTP headers” is set accordingly.

At S450, any header that is not identified (e.g., by the above-mentioned regular expression) is counted and added to the respective paraphrase, the total number of unknown headers. If no unknown headers are found, the respective paraphrase value is set to zero.

At S460, any cookie header in the received HTTP request is identified, and a number of key: value in the cookie are counted and added to the respective paraphrase, the total number of key:value in cookie. If no cookie header is found, the respective paraphrase value is set to zero.

At S470, any query arguments in the URL of the received HTTP request is identified and parsed, and the total number of query arguments URL are counted and set at the respective paraphrase, the number of query arguments in the request URL. If no query argument is found, the respective paraphrase value is set to zero.

At S480, the User Agent and the total length of the received HTTP request are identified and parsed. Further, the length of User Agent header is counted and set to the respective paraphrase, the length of User Agent header. If no User Agent HTTP header is found, the respective paraphrase value is set to zero. Same applies to the User Agent actual value. Furthermore, the total length in bytes of the received HTTP request is counted and set to the respective paraphrase, the total length HTTP requests. In an embodiment, the total length of the HTTP request is defined by ranges, e.g., 0-99, 100-199, until 390-3999 bytes. In yet another embodiment, the count of origin of the source IP generated the request (GEO IP) is identified and set, and the source IP can be defined by the Layer 3 IP headers or by X-Forwarded FOR HTTP header.

The processes described herein are performed for sampled HTTP requests sent by both client device 120 and/or the attack tool 125 toward the victim server 130 (as in FIG. 1). The requests can be converted into one or more paraphrases, each of which with a respective paraphrase vector.

FIG. 6 shows an example flowchart S260 illustrating the process of generating the signature of an attack tool (attacker) during an active attack and according to an embodiment. This process is realized at the end of each time window during an active attack.

At S610, baseline paraphrase distributions are computed using the BPBFs. This may include transforming the baseline paraphrase histogram (represented by the BPBFs) to a probability distribution function. In an embodiment, the baseline paraphrase distributions are computed as follows:

$$i , j [ n ] = \frac{{ParaValueOccMean}_{i , j} [ n ]}{{Σ}_{k} {ParaValueOccMean}_{k , j} [ n ]} \qquad Equ . 2$$

where, the BaselineParaValueProb_{i,j} [n] is the probability of appearance of Paraphrase Value i, belongs to Paraphrase j, for time window n. The ParaValueOccMean_{i,j} [n] is the average (baseline) occurrences for Paraphrase Value i, belongs to Paraphrase j, for time window n, as recorded in the baseline paraphrase buffers. Elaborated also in FIG. 1.

At S620, attack paraphrase distributions are computed using the APBFs. This may include a transformation attack paraphrase histogram (represented by the APBFs) to a probability distribution function. In an embodiment, the attack paraphrase distributions are computed as follows:

$${AttackParaValueProb}_{i , j} [ n ] = \frac{{ParaValueOccMean}_{i , j} [ n ]}{{Σ}_{k} {ParaValueOccMean}_{k , j} [ n ]} \qquad Equ . 3$$

where, AttackParaValueProb_{i,j} [n] is the probability of appearance of Paraphrase Value i, belongs to Paraphrase j, for time window n of an active attack. The ParaValueOccMean_{i,j} [n] is the aggregated occurrences for Paraphrase Value i, belongs to Paraphrase j, for time window n, as recorded in the attack paraphrase buffers.

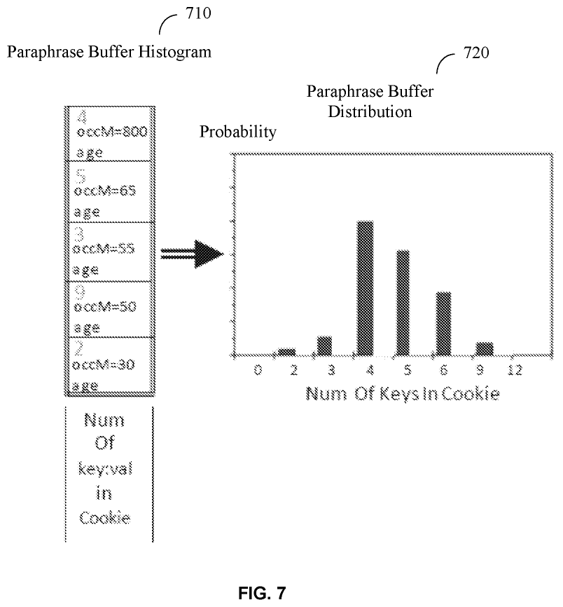

An example demonstrating the transformation from a histogram to paraphrase distributions (either for attack or baseline) is shown in FIG. 7. In this example, the paraphrase is the “Num of key:val in Cookie”. The respective paraphrase is labeled 710 and the distribution graph is labeled 710.

At S630, a probability Pⱼattack[n] of an attacker to generate an attack using a specific paraphrase (j), each specific value is computed. In an embodiment, the Pⱼattack [n] is computed as follows:

$${P}_{j} attacker [ n ] = {P}_{j} attack [ n ] \cdot \frac{1 + AF [ n ]}{AF [ n ]} - {P}_{j} baseline \cdot \frac{1}{AF [ n ]} \qquad Equ . 4$$

where, Pⱼattack [n] and Pⱼbaseline are derived from the computed attack paraphrase distributions and baseline paraphrase distributions, respectively. The function AF[n] is the attack factor, i.e. the RPS generated by the attacker divided by the RPS generated by the legitimate clients:

$$AF [ n ] = \frac{AttackerRPS [ n ]}{LegitRPS [ n ]} \qquad Equ . 5$$

and may be completed as follows:

$$AF [ n ] = {\sum }_{l = 1}^{n - a \cdot d \cdot t} \frac{( AttackRSP [ l ] - BasleineRPS )}{BaselineRPS} \qquad Equ . 5.1$$

where, ‘a.d.t.’ is the actual attack detection time, and ‘n’ is the current time window. AttackRPS[n] is the true average RPS as measured during the time window n when the attack is active. The BaselineRSP represents the average legitimate RPS as a measure before the attack has started. In an embodiment, the BaselineRSP is computed as an average over one hour period before the attack has started. In yet another embodiment, the BaselineRSP is computed as the summation of an average over one hour period before the attack has started and a predefined number of corresponding standard deviations.

In cases the APBFs average paraphrase values are computed using Equ. 1.1, the AF[n] is calculated as an average using an Alpha filter over AF[n] values using:

$$AF [ n + 1 ] = AF [ n ] \cdot ( 1 - α ) + \frac{AttackRPS [ n + 1 ] - BasleineRPS}{BaslineRPS} α \qquad Equ . 5.2$$

In an example embodiment, with correspondence to Equ. 1.1, the Alpha is selected as 0.75 to enable the fast integration time, e.g., a couple of ten seconds, required for the fast adaptation to the attacker requests' structure.

It should be noted that the S630 is performed for each paraphrase.

At S640, the attacker probabilities Pⱼattacker [n], for each paraphrase j and each of its values are compared to a predefined attacker threshold. All the respective paraphrase values of attacker probabilities Pⱼattacker [n] exceeding the threshold are added to an attacker buffer, and the rest paraphrase values are added to a legitimate buffer. The paraphrase values in the attack buffer are candidates to be included in the adaptive signature. That is, such paraphrase values are likely to be executed by an attacker and generated on-going by the attack tool the attacker is using. In an embodiment, the attacker threshold is preconfigured and defines the mitigation or sensitivity.

At S650, the signature eligibility of each paraphrase is determined. That is, the signature eligibility determines if the respective paraphrase values of each paraphrase in the attacker buffer should be included, or not included in the signature. The eligibility is determined by summing the baseline (peace time) distributions of all paraphrase values in the legitimate buffer and comparing the summation to a predefined legitimate threshold. If the distribution sum exceeds the legitimate threshold, the paraphrase values in the attacker buffer are considered signature eligible because the required level of legitimate traffic, with certain values in the legitimate buffer, is expected to be excluded from the signature. If the distributions sum exceeds the legitimate threshold, the paraphrase values in the APBFs are eliminated from the signature, and the paraphrase is not part of the signature. This activity ensures the efficiency of the generated signature. In an embodiment, the legitimate threshold is preconfigured and defines the mitigation or sensitivity.

At S660, all paraphrase values that are signature eligible are added to a data structure representing the signature of the attacker executing the on-going attack. The signature characterizes the attacker and further used in the next time window for the actual attack mitigation.

Following are two examples, showing eligible and non-eligible paraphrases. In the first example, the paraphrase is Num of Keys in Cookie. The paraphrase values are ‘0’, ‘1’, ‘2’, ‘3’, ‘4’, ‘5’, and ‘6’. The computed Pⱼattacker is as follows:
Pⱼattacker(paraValue=0)=0.495; Pⱼattacker(paraValue=1)=0.098;
Pⱼattacker(paraValue=2)=0.098, Pⱼattacker(paraValue=3)=0.101;
Pⱼattacker(paraValue=4)=0.104; Pⱼattacker(paraValue=5)=0.102; and
Pⱼattacker(paraValue=6)=0

The attacker threshold is set at 0.1, thus, all values but “paraValue=6” will be included in the attacker buffer. The legitimate threshold is 0.01, The total legit probability is 23%, thus the paraphrase (Num of Keys in Cookie) is eligible and will be included in the attacker's signature. This enables signature accuracy and efficacy.

In the second example, the paraphrase is a HTTP method. The paraphrase values are ‘GET’, ‘POST’, ‘DELETE’, ‘HEAD’, and ‘PUT’. The computed Pⱼattacker values are: Pⱼattacker(paraValue=GET)=0.498; Pⱼattacker(paraValue=POST)=0.501; Pⱼattacker(paraValue=DELETE)=0; Pⱼattacker(paraValue=HEAD)=0; and Pⱼattacker(paraValue=PUT)=0.

The attacker threshold is set 0.2, thus all 2 values ‘GET’ and ‘POST’ will be included in the attacker buffer. The total legit probability is about 0%, thus, the paraphrase (HTTP method) is ineligible and will not be included in the attacker's signature.

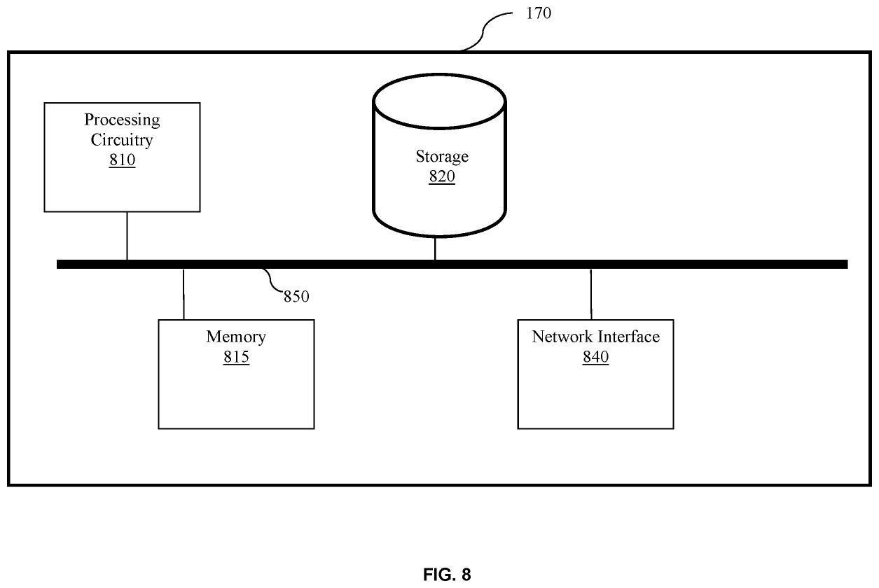

FIG. 8 is an example block diagram of the device 170 implemented according to an embodiment. The device 170 includes a processing circuitry 810 coupled to a memory 815, a storage 820, and a network interface 840. In another embodiment, the components of the device 170 may be communicatively connected via a bus 850.

The processing circuitry 810 may be realized as one or more hardware logic components and circuits. For example, and without limitation, illustrative types of hardware logic components that can be used include field-programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 815 may be volatile (e.g., RAM, etc.), non-volatile (e.g., ROM, flash memory, etc.), or a combination thereof. In one configuration, computer-readable instructions to implement one or more embodiments disclosed herein may be stored in storage 820.

In another embodiment, the memory 815 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by one or more processors, cause the processing circuitry 810 to perform the various processes described herein. Specifically, the instructions, when executed, cause the processing circuitry 810 to perform the embodiments described herein.

The storage 820 may be magnetic storage, optical storage, and the like, and may be realized, for example, as flash memory or other memory technology, CD-ROM, Digital Versatile Disks (DVDs), or any other medium which can be used to store the desired information.

The network interface 840 allows the device to communicate at least with the servers and clients. It should be understood that the embodiments described herein are not limited to the specific architecture illustrated in FIG. 8, and other architectures may be equally used without departing from the scope of the disclosed embodiments. Further, system 110 can be structured using the arrangement shown in FIG. 8

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to promoting the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

What is claimed is:

1. A method for generating application-layer signatures characterizing advanced application-layer attacks, comprising:
determining applicative baseline distributions of attributes included in transactions directed to a protected entity during peacetime;
determining attack distributions of applicative attributes included in transactions directed to a protected entity during an on-going application-layer attack;
determining, based on the applicative baseline distributions and the attack distributions of applicative attributes, a probability of an attacker executing the on-going application-layer attack to generate an attack using at least one attribute; and
generating an application-layer signature designating applicative attributes determined to be eligible based on their respective probabilities, wherein the application-layer signature characterizes behavior of the attacker executing the on-going application-layer attack.

2. The method of claim 1, further comprising:
maintaining attributes of transactions, directed to a protected entity, in a paraphrase, wherein each paraphrase includes at least one paraphrase value, wherein a paraphrase value represents an applicative attribute in a transaction.

3. The method of claim 2, wherein the paraphrase value is any one of: an HTTP VERB; a number of path elements in a request URL path; a number of query arguments in the request URL; a User Agent actual value, a number of key:values cookie elements in cookie; a length of User Agent header; a total length in bytes of the request; a total number of known HTTP headers; a total number of unknown headers; and existence, or non-existence, of a predefined set of HTTP headers, existence of a dynamically defined set of HTTP headers, a geographical information on an origin of the attacker.

4. The method of claim 2, further comprising:
sampling transactions received during a time window;
for each time window,
building a set of window paraphrase buffers (WPBFs);
building a set of baseline paraphrase buffers (BPBFs) from transactions directed to the protected entity during peacetime, wherein the BPBFs represent a paraphrase normal behavior.

5. The method of claim 4, further comprising:
sampling transactions received during a time window;
for each time window,
building a set of window paraphrase buffers (WPBFs);
building, for each time window, a set of attack paraphrase buffers (APBFs) from transactions received during the on-going application-layer attack, wherein the APBFs represent a paraphrase attack time behavior for a duration of the on-going application-layer attack.

6. The method of claim 5, wherein building the set of WPBFs further comprises:
vectoring a set of paraphrases derived from the received transactions during a time window; and
buffering the paraphrase vectors to provide the WPBFs.

7. The method of claim 4, wherein building the set of BPBFs further comprises:
updating values from the WPBFs into the BPBFs.

8. The method of claim 7, further comprises:
computing paraphrase values mean occurrences for the BPBFs for a current time window based on an average of occurrences for paraphrase values in the BPBFs computed for a previous time window, a total of occurrences for paraphrase values in the WPBFs for a current time window, and an Alpha filter.

9. The method of claim 4, wherein building the APBFs further comprises:
updating the values from the WPBFs into the APBFs; and
updating paraphrase value occurrences based on transactions directed to the protected entity during the on-going application-layer attack.

10. The method of claim 9, wherein updating the APBFs further comprises:
computing paraphrase values mean occurrences for the APBFs for a current time window, an average of occurrences for paraphrase values in the APBFs computed for a previous time window, a total occurrences for paraphrase values in the WPBFs, and an Alpha filter, wherein the Alpha filer is configured to short adoption to changes.

11. The method of claim 4, wherein generating the application-layer signature further comprises:
computing, using a first probability distribution function, baseline distributions based on values in the BPBFs;
computing, using a second probability distribution function, attack distributions based on values in the APBFs; and
computing, for each paraphrase value in baseline distributions and attack distributions the probability of an attacker to execute attack using at least one paraphrase value, wherein the application-layer signature includes a set of paraphrase values for mitigating an attacker executing the on-going application-layer attack.

12. The method of claim 11, further comprising:
comparing an attacker probability computed for each paraphrase value to a predefined attacker threshold; and
including in the application-layer signature paraphrase values having an attacker probability higher than the predefined attacker threshold.

13. The method of claim 11, further comprising:
determining eligibility of the generated application-layer signature.

14. The method of claim 1, further comprising:
causing a mitigation resource to mitigate the on-going application-layer attack using an application-layer signature determined to be eligible.

15. The method of claim 14, further comprising:
converting an incoming transaction into a paraphrase vector;
comparing the paraphrase vector to the eligible application-layer signature;
determining the incoming transaction is a legitimate request when the paraphrase vector does not match the eligible application-layer signature; and
determining the incoming transaction is generated by the attacker when the paraphrase vector matches the eligible application-layer signature.

16. The method of claim 15, wherein the match is determined based on a number of predefined matching paraphrases between the paraphrase vector of the received incoming transaction and the eligible application-layer signature.

17. The method of claim 14, further comprising:
generating a policy to mitigate the attacker, based on the eligible application-layer signature; and
providing the policy to a mitigation resource to perform at least one mitigation action on requests determined to be generated by the attack tool.

18. The method of claim 17, wherein the at least one mitigation action includes blocking the attacker.

19. The method of claim 1, further comprising:
determining the attack distributions of applicative attributes upon receiving an indication on the application-layer attack directed toward a protected entity.

20. The method of claim 21, wherein the on-going application-layer attack is a DDOS attack realized as a HTTP flood application-layer attack.

21. The method of claim 20, further comprises:
sampling the transactions, wherein the transactions are HTTP requests.

22. The method of claim 1, wherein the method is performed by any one of: a DDOS mitigation device, a WAF device, a WEB server, a WEB cache (CDN), and a WEB proxy.

23. A non-transitory computer readable medium having stored thereon instructions for causing a processing circuitry to execute a process, the process comprising:
determining applicative baseline distributions of attributes included in transactions directed to a protected entity during peacetime;
determining attack distributions of applicative attributes included in transactions directed to a protected entity during an on-going application-layer attack;
determining, based on the applicative baseline distributions and the attack distributions of applicative attributes, a probability of an attacker executing the on-going application-layer attack to generate an attack using at least one attribute; and
generating an application-layer signature designating applicative attributes determined to be eligible based on their respective probabilities, wherein the application-layer signature characterizes behavior of the attacker executing the on-going application-layer attack.

24. A system for generating dynamic applicative signatures of by application layer flood attack tools, comprising:
a processing circuitry; and
a memory, the memory containing instructions that, when executed by the processing circuitry, configure the system to:
determine applicative baseline distributions of attributed included in transactions directed to protect an entity during peacetime;
determine attack distributions of applicative attributes included in transactions directed to a protected entity during an on-going application-layer attack;
determine, based on the applicative baseline distributions and the attack distributions of applicative attributes, a probability of an attacker to execute the on-going application-layer attack to generate an attack that uses at least one attribute; and
generate an application-layer signature that designates applicative attributes determined to be eligible based on their respective probabilities, wherein the application-layer signature characterizes behavior of the attacker executing the on-going application-layer attack.

25. The system of claim 24, wherein the system is further configured to:
maintain attributes of transactions in a paraphrase, wherein each paraphrase includes at least one paraphrase value, wherein a paraphrase value represents an applicative attribute in a transaction.

26. The system of claim 25, wherein the paraphrase value is any one of: an HTTP VERB; a number of path elements in a request URL path; a number of query arguments in the request URL; a number of key:values cookie elements in cookie; a length of User Agent header; a total length in bytes of the request; a total number of known HTTP headers; a total number of unknown headers; and existence, or non-existence, of a predefined set of HTTP headers.

27. The system of claim 25, wherein the system is further configured to:
sample transactions received during a time window;
for each time window,
build a set of window paraphrase buffers (WPBFs);
build a set of baseline paraphrase buffers (BPBFs) from transactions directed to the protected entity during peacetime, wherein the BPBFs represent a paraphrase normal behavior.

28. The system of claim 27, wherein the system is further configured to:
sample transactions received during a time window and attack time;
for each time window,
build a set of window paraphrase buffers (WPBFs); and
build, for each time window, a set of attack paraphrase buffers (APBFs) from transactions received during the on-going application-layer attack, wherein the APBFs represent a paraphrase attack time behavior for a duration of the on-going application-layer attack.

29. The system of claim 27, wherein the system is further configured to:
vector a set of paraphrases derived from the received transactions during a time window; and
buffer the paraphrase vectors to provide the WPBFs.

30. The system of claim 27, wherein the system is further configured to:
update values from the WPBFs into the BPBFs.

31. The system of claim 30, wherein the system is further configured to:
compute paraphrase values mean occurrences for the BPBFs for a current time window based on an average of occurrences for paraphrase values in the BPBFs calculated for a previous time window, a total of occurrences for paraphrase values in the WPBFs for the current time window, and an Alpha filter.

32. The system of claim 27, wherein the system is further configured to:
update values from the WPBFs into the APBFs; and
update paraphrase value occurrences based on transactions directed to the protected entity during the on-going application-layer attack.

33. The system of claim 32, wherein the system is further configured to:
compute paraphrase values mean occurrences for the APBFs for a current time window, an average of occurrences for paraphrase values in the APBFs calculated for a previous time window, a total of occurrences for paraphrase values in the WPBFs, and an Alpha filter, wherein the Alpha filer is configured to short adoption to changes.

34. The system of claim 27, wherein the system is further configured to:
compute, using a first probability distribution function, baseline distributions based on values in the BPBFs;
compute, using a second probability distribution function, attack distributions based on values in the APBFs; and
compute, for each paraphrase value in baseline distributions and attack distributions the probability of an attacker to execute attack using at least one paraphrase value, wherein the application-layer signature includes a set of paraphrase values for mitigating an attacker executing the on-going application-layer attack.

35. The system of claim 34, wherein the system is further configured to:
compare, an attacker probability computed for each paraphrase value to a predefined attacker threshold; and
include in the application-layer signature paraphrase values having an attacker probability higher than the predefined attacker threshold.

36. The system of claim 34, wherein the system is further configured to:
determine eligibility of the generated application-layer signature.

37. The system of claim 24, wherein the system is further configured to:
cause a mitigation resource to mitigate the on-going application-layer attack using an application-layer signature determined to be eligible.

38. The system of claim 37, wherein the system is further configured to:
convert an incoming transaction into a paraphrase vector;
compare the paraphrase vector to the eligible application-layer signature;
determine the incoming transaction is a legitimate request when the paraphrase vector does not match the eligible application-layer signature; and
determine the incoming transaction is generated by the attack tool when the paraphrase vector matches the eligible application-layer signature.

39. The system of claim 38, wherein the match is determined based on a number of predefined matching paraphrases between the paraphrase vector of the received incoming transaction and the eligible application-layer signature.

40. The system of claim 37, wherein the system is further configured to:
generate a policy to mitigate the attack tool, based on the eligible application-layer signature; and
provide the policy to a mitigation resource to perform at least one mitigation action on requests determined to be generated by the attack tool.

41. The system of claim 40, wherein the at least one mitigation action includes blocking the attack tool.

42. The system of claim 24, wherein the system is further configured to:
upon receiving an indication on the application-layer attack directed toward a protected entity, determine the attack distributions of applicative attributes.

43. The system of claim 24, wherein the on-going application-layer attack is a DDOS attack realized as a HTTP flood application-layer attack.

44. The system of claim 43, wherein the system is further configured to:
sample the transactions wherein the transactions are HTTP requests.

45. The system of claim 24, wherein the method is performed by any one of: a DDOS mitigation device, a WAF device, a WEB server, a WEB cache (CDN), and a WEB proxy.
